(19) United States
(12) Patent Application Publication
(10) Pub. No.: US 2024/0266662 A1
(43) Pub. Date: Aug. 8, 2024

(54) SODIUM-BASED BATTERY FOR HYBRID VEHICLES

(71) Applicant: NEXPOWERENERGY INC., La Verne, CA (US)

(72) Inventors: JACK TALUN CHIOU, LA VERNE, CA (US); DAVID HSIAO-PAI SHEN, Arcadia, CA (US)

(21) Appl. No.: 18/596,474

(22) Filed: Mar. 5, 2024

Related U.S. Application Data
(63) Continuation-in-part of application No. 17/346,193, filed on Jun. 11, 2021.

(51) Int. Cl. H01M 50/249; B60K 6/28; H01M 10/054; H01M 10/42; H01M 50/211; H01M 50/213; H01M 50/284

(52) U.S. Cl. CPC H01M 50/249; H01M 10/054; H01M 10/425; H01M 50/211; H01M 50/213; H01M 50/284; B60K 6/28; B60Y 2200/92; B60Y 2400/112; H01M 2220/20

(57) ABSTRACT

A battery module for an electric vehicle is provided. The battery module includes a case, multiple sodium-ion rechargeable battery cells, and an overcharge protection circuit. The sodium-ion rechargeable battery cells are stored inside the case and are connected in series. Each of the multiple sodium-ion rechargeable battery cells has a nominal voltage and a maximum voltage. The overcharge protection circuit has a voltage threshold for preventing an overcharging of each of the sodium-ion rechargeable battery cells. The voltage threshold is larger than the nominal voltage and smaller than the maximum voltage.

### CROSS-REFERENCE TO RELATED APPLICATION

The present disclosure claims the benefit of, and is a continuation-in-part of, U.S. Non-Provisional patent application Ser. No. 17/346,193, filed on Jun. 11, 2021, the content of which is hereby incorporated fully by reference into the present disclosure.

### FIELD

The present disclosure generally relates to electrochemical batteries. In particular, the present disclosure relates to batteries used in electric vehicles, such as hybrid-electric vehicles or plug-in hybrid vehicles (PHEV) that are collectively referred to as “HEVs.” The HEVs derive some or all of their motive power through one or more batteries or a battery system. Although most implementations of the present disclosure may describe exemplary batteries that are compatible with HEVs, the exemplary batteries may also be compatible with any type of fully-electric vehicles, which operates via electric power, or any type of semi-electric vehicles, such as Hybrid vehicles, Plug-In Hybrid vehicles, which operate via an internal combustion engine with an electric motor, with separate batteries for each of the engine and the motor.

### BACKGROUND

HEVs make up a significant portion of the automobile market mainly due to the ability to promote fuel economy and reduce vehicle emissions by using a combination of electric power and combustion. Many efforts have been made to increase the efficiency of automobile (e.g., cars, trucks, etc.) batteries. One of the ongoing goals for the automobile battery is to retain higher energy density, which means higher voltage and lighter weight, while providing a higher total driving range (e.g., distance).

Conventional batteries for an HEV may use nickel metal hydride (Ni-MH) cells. However, Ni-MH battery cells are often heavier than lithium ion (Li-ion) battery cells and have a lower nominal voltage. A battery module in a Toyota® Prius® has six Ni-MH battery cells and weighs more than 1 kilogram. The generated voltage of a Toyota Prius® battery pack is 7.2V. A battery module with five Li-ion battery cells weighs about 1.2 kilograms but has 16V output. That is to say, a battery module with five Li-ion battery cells weighs less than two Toyota® Prius® battery packs and has a higher voltage. Therefore, Li-ion battery cells have a high energy density.

While Ni-MH battery cells do not require a balancing circuit due to their characteristics, such a balancing circuit is needed for Li-ion battery cells within a Li-ion battery module to ensure even charging across the battery cells.

The temperature of the battery cells, especially during charging and discharging, affects their performance. Therefore, there remains a need to provide compact cooling structure for a Li-ion battery pack.

A sodium-based or an Na-based (e.g., sodium-ion, Na-ion, etc.) battery cell and the related modules may be more suitable than a Li-based (e.g., Li-ion, etc.) battery cell and the related modules, or may even be a better interchangeable alternative to a nickel-based or Ni-based (e.g., Ni-MH, etc.) battery cell and the related modules to be used in an HEV, due to the more desirable operating parameters (e.g., temperature, range, density, etc.) and lower costs of the Na-based battery cell, which is ideal, especially, in replacing the Ni-based battery cell.

Therefore, there is room for improvement within the art.

### SUMMARY

In accordance with a first aspect of the present disclosure, a battery module for an electric motor vehicle may include a case, multiple rechargeable battery cells, and an overcharge protection circuit. The rechargeable battery cells may be stored inside the case and may be connected in series. Each of the rechargeable battery cells may include a nominal voltage and a maximum voltage. The overcharge protection circuit may have a voltage threshold for each of the rechargeable battery cells to prevent overcharging. The voltage threshold may be larger than the nominal voltage and smaller than the maximum voltage.

In an implementation of the first aspect, each of the rechargeable battery cells may be lithium-based and selected from lithium titanate Li₄Ti₅O₁₂, lithium iron phosphate LiFePO₄, lithium cobalt oxide LiCoO₂, lithium manganese oxide LiMn₂O₄, lithium nickel manganese cobalt oxide LiNiMnCoO₂ (NMC), lithium nickel cobalt oxide LiNiCoO₂ (NC), or lithium nickel cobalt aluminum oxide LiNiCoAlO₂.

In another implementation of the first aspect, the case may further include at least one air vent. A number of the rechargeable battery cells may be five.

In yet another implementation of the first aspect, the nominal voltage may be the same for each of the rechargeable battery cells. The overcharge protection circuit may prevent overcharging of each of the rechargeable battery cells through dissipation via resistors.

In accordance with a second aspect of the present disclosure, a battery module for an electric motor vehicle may include a rectangular case and multiple rechargeable battery cells. The rechargeable battery cells may be stored inside the case and may be connected in series. The case may include at least one air vent on at least one side of the case.

In an implementation of the second aspect, each of the rechargeable battery cells may be lithium-based and selected from lithium titanate Li₄Ti₅O₁₂, lithium iron phosphate LiFePO₄, lithium cobalt oxide LiCoO₂, lithium manganese oxide LiMn₂O₄, lithium nickel manganese cobalt oxide LiNiMnCoO₂ (NMC), lithium nickel cobalt oxide LiNiCoO₂ (NC), or lithium nickel cobalt aluminum oxide LiNiCoAlO₂.

In another implementation of the second aspect, all of the rechargeable battery cells may be lithium titanate Li₄Ti₅O₁₂, and a number of the rechargeable battery cells may be seven.

In yet another implementation of the second aspect, all of the rechargeable battery cells may be lithium iron phosphate LiFePO₄, and a number of the rechargeable battery cells may be five.

In yet another implementation of the second aspect, a number of the rechargeable battery cells may be four, and each of the plurality of rechargeable battery cells may be selected from lithium cobalt oxide LiCoO₂, lithium manganese oxide LiMn₂O₄, lithium nickel manganese cobalt oxide LiNiMnCoO₂ (NMC), lithium nickel cobalt oxide LiNiCoO₂ (NC), and lithium nickel cobalt aluminum oxide LiNiCoAlO₂.

In yet another implementation of the second aspect, the battery module may include an overcharge protection circuit that has a voltage threshold for each of the rechargeable battery cells to prevent overcharging. Each of the rechargeable battery cells may have a nominal voltage and a maximum voltage. The voltage threshold may be larger than the nominal voltage and smaller than the maximum voltage. The overcharge protection circuit may prevent overcharging through dissipation via resistors.

In accordance with a third aspect of the present disclosure, a battery module for an electric motor vehicle may include a case and multiple rechargeable battery cells. The rechargeable battery cells may be stored inside the case and may be connected in series. The rechargeable battery cells may be stored in a parallel configuration inside the case in multiple rows. At least one of the rechargeable battery cells may be stored in each of the rows.

In an implementation of the third aspect, each of the rechargeable battery cells may be lithium-based and selected from lithium titanate Li₄Ti₅O₁₂, lithium iron phosphate LiFePO₄, lithium cobalt oxide LiCoO₂, lithium manganese oxide LiMn₂O₄, lithium nickel manganese cobalt oxide LiNiMnCoO₂ (NMC), lithium nickel cobalt oxide LiNiCoO₂ (NC), or lithium nickel cobalt aluminum oxide LiNiCoAlO₂.

In an implementation of the third aspect, the battery module may include an overcharge protection circuit that has a voltage threshold for each of the rechargeable battery cells to prevent overcharging. Each of the rechargeable battery cells may have a nominal voltage and a maximum voltage. The voltage threshold may be larger than the nominal voltage and smaller than the maximum voltage.

In another implementation of the third aspect, the case may include at least one air vent.

In yet another implementation of the third aspect, the rows may include a first row storing three of the rechargeable battery cells and a second row storing two of the rechargeable battery cells. A free battery cell space in the second row may store an overcharge protection circuit.

In accordance with a fourth aspect of the present disclosure, a battery module for an electric vehicle may include a case, multiple sodium-ion rechargeable battery cells, and an overcharge protection circuit. The sodium-ion rechargeable battery cells may be stored inside the case and may be connected in series. Each of the sodium-ion rechargeable battery cells may have a nominal voltage and a maximum voltage. The overcharge protection circuit may have a voltage threshold for preventing an overcharging of each of the sodium-ion rechargeable battery cells. The voltage threshold may be larger than the nominal voltage and smaller than the maximum voltage.

In an implementation of the fourth aspect, the nominal voltage of each of the multiple sodium-ion rechargeable battery cells may be the same.

In another implementation of the fourth aspect, the multiple sodium-ion rechargeable battery cells may include five cells.

In yet another implementation of the fourth aspect, the five cells may provide a combined nominal voltage of 15.5V.

In yet another implementation of the fourth aspect, each of the multiple sodium-ion rechargeable battery cells may have a cylindrical-shaped housing.

In yet another implementation of the fourth aspect, the battery module may have an operating temperature from −40 degrees ° C. to 60 degrees ° C.

In yet another implementation of the fourth aspect, the overcharge protection circuit may prevent the overcharging of each of the multiple sodium-ion rechargeable battery cells through dissipation via resistors.

In yet another implementation of the fourth aspect, the battery module may include a battery-free cell space for storing the overcharge protection circuit.

In accordance with a fifth aspect of the present disclosure, a battery module for an electric vehicle may include a case, multiple sodium-ion rechargeable battery cells, and an overcharge protection circuit. The sodium-ion rechargeable battery cells may be stored inside the case and may be connected in series. The sodium-ion rechargeable battery cells may be stored in a parallel configuration inside the case. Each of the sodium-ion rechargeable battery cells may have a nominal voltage and a maximum voltage. The overcharge protection circuit may have a voltage threshold for preventing an overcharging of each of the sodium-ion rechargeable battery cells. The voltage threshold may be larger than the nominal voltage and smaller than the maximum voltage.

In an implementation of the fifth aspect, the nominal voltage of each of the multiple sodium-ion rechargeable battery cells may be the same.

In another implementation of the fifth aspect, the multiple sodium-ion rechargeable battery cells may include five cells.

In yet another implementation of the fifth aspect, the five cells may provide a combined nominal voltage of 15.5V.

In yet another implementation of the fifth aspect, each of the multiple sodium-ion rechargeable battery cells may have a cylindrical-shaped housing.

In yet another implementation of the fifth aspect, the battery module may have an operating temperature from −40 degrees ° C. to 60 degrees ° C.

In yet another implementation of the fifth aspect, the overcharge protection circuit may prevent the overcharging of each of the multiple sodium-ion rechargeable battery cells through dissipation via resistors.

In yet another implementation of the fifth aspect, the battery module may include a battery-free cell space for storing the overcharge protection circuit.

### BRIEF DESCRIPTION OF THE DRAWINGS

Implementations of the present disclosure will now be described, by way of example only, with reference to the attached figures.

FIG. 1 is a schematic drawing of a related art Ni-MH HEV battery installed in an HEV.

FIG. 2 is a schematic drawing of a related art Ni-MH battery cell.

FIG. 3 is a schematic drawing illustrating an example LiFePO₄ cell structure, in accordance with an example implementation of the present disclosure.

FIG. 4 is a schematic drawing illustrating an example battery module case, in accordance with an example implementation of the present disclosure.

FIG. 5 is a schematic drawing illustrating an example voltage balancing module, in accordance with an example implementation of the present disclosure.

FIG. 6 is a schematic drawing illustrating an example LiFePO₄ battery module with a voltage balancing module, in accordance with an example implementation of the present disclosure.

FIG. 7 is a schematic drawing illustrating an example LiFePO₄ lithium battery module with a balancer, in accordance with an example implementation of the present disclosure.

FIG. 8 illustrates fourteen example LiFePO₄ battery modules as alternative replacements for the twenty-eight Ni-MH-based battery modules.

FIG. 9 is a schematic drawing illustrating an example sodium-based battery cell structure, in accordance with an example implementation of the present disclosure.

FIG. 10 is a schematic drawing illustrating an example sodium-based battery module with a balancer, in accordance with an example implementation of the present disclosure.

### DETAILED DESCRIPTION

It will be appreciated that for simplicity and clarity of illustration, where appropriate, reference numerals have been repeated among the different figures to indicate corresponding or analogous elements. In addition, numerous specific details are set forth in order to provide a thorough understanding of the implementations described herein. However, it will be understood by those of ordinary skill in the art that the implementations described herein can be practiced without these specific details. In other instances, methods, procedures, and components have not been described in detail so as not to obscure the related relevant feature being described. Also, the description is not to be considered as limiting the scope of the implementations described herein. The drawings are not necessarily to scale and the proportions of certain parts have been exaggerated to better show details and features of the present disclosure.

The term “comprising” when utilized, means “including, but not necessarily limited to”; it specifically indicates open-ended inclusion or membership in the so-described combination, group, series, and the equivalent. According to any sentence, paragraph, point, action, behavior, term, alternative, aspect, example, implementation, or claim described in the present disclosure, “X/Y” may include the meaning of “X or Y”. According to any sentence, paragraph, point, action, behavior, term, alternative, aspect, example, implementation, or claim described in the present disclosure, “X/Y” may also include the meaning of “X and Y”. According to any sentence, paragraph, point, action, behavior, term, alternative, aspect, example, implementation, or claim described in the present disclosure, “X/Y” may also include the meaning of “X and/or Y”.

An HEV has an internal combustion engine (e.g., operates on fuel such as gasoline, etc.) and an electric motor which are separated from one another. The HEV may utilize electric power stored in a Ni-MH battery instead of power from combustion whenever possible. The HEV may operate through the electric motor when driven at low speeds, may require energy from the internal combustion engine upon acceleration, and may use both the electric motor and the internal combustion engine to sufficiently power the vehicle during light acceleration.

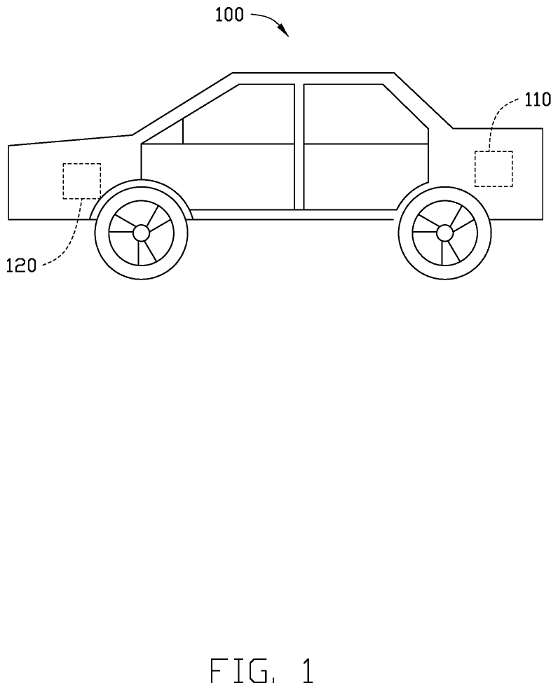

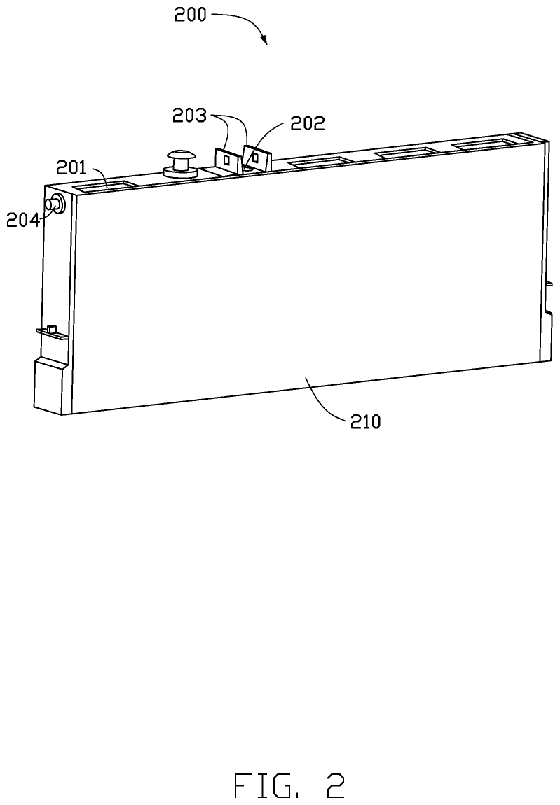

FIG. 1 is a schematic drawing of a related art Ni-MH HEV battery installed in an HEV. FIG. 2 is a schematic drawing of a related art Ni-MH battery cell.

In FIG. 1, the HEV 100 has an internal combustion engine 120. The Ni-MH battery pack 110 is connected to an electric motor (not explicitly shown). The Ni-MH battery pack 110 provides DC power, which is transmitted to an electric motor that drives the wheels of the HEV 100 when the vehicle is driven at low speeds.

The battery pack of an HEV may include a number of Ni-MH battery modules. For example, a Toyota® Prius® battery pack may include 28 Ni-MH battery modules. Each of these battery modules 200 (illustrated in FIG. 2) may hold a charge of 7.2 volts.

In FIG. 2, the battery module 200 may contain, for example, six Ni-MH battery cells in series and enclosed in a plastic case 210. A one-way vent 201 is provided on an upper surface of the case 210 for pressure relief. The upper surface of the case may also include a receptacle for holding a temperature sensor 202. The receptacle may be two clips 203 provided to hold the temperature sensor 202 in place. An electrode terminal 204 is provided on a side surface of the case 210 to be electrically connected to other battery modules.

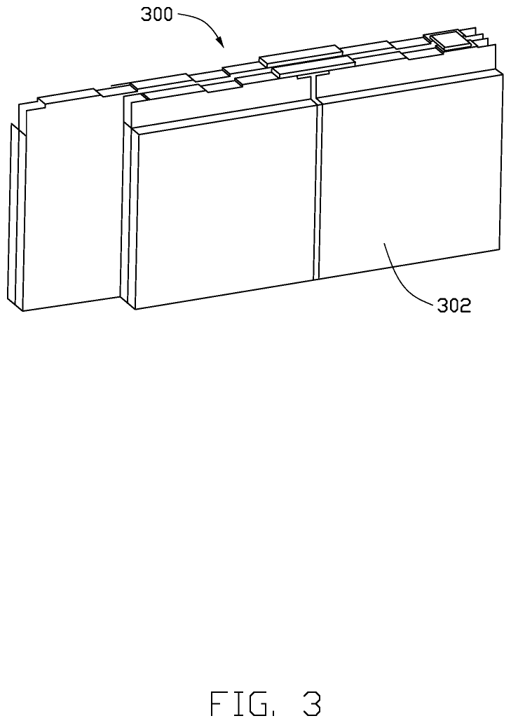

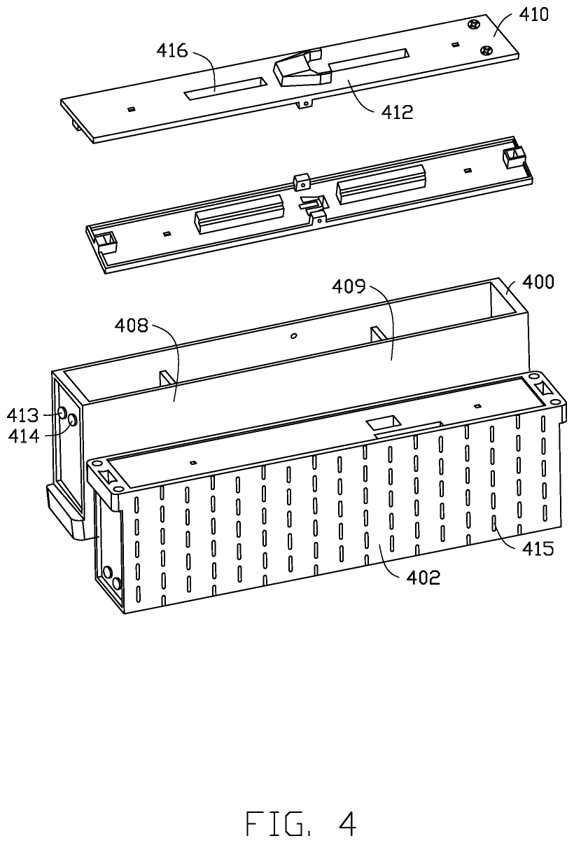

FIG. 3 is a schematic drawing illustrating an example LiFePO₄ cell structure in accordance with an example implementation of the present disclosure. FIG. 4 is a schematic drawing illustrating an example battery module case in accordance with an example implementation of the present disclosure.

FIG. 3 illustrates an example LiFePO₄ battery cell structure 300 in a 5-series (5S) configuration. The example LiFePO₄ battery cell structure 300 may include a plurality of battery cells 302, for example five LiFePO₄ battery cells (e.g., lithium battery cells). FIG. 4 illustrates a battery case 400. In FIG. 4, the battery case 400 may include a front side 402, a rear side 406, a first lateral side 408, a second lateral side 409 opposite and parallel to the first lateral side 408, a top side 410, and an underside 411. The top side 410 of the case 400 may include a holder 412 for storing a temperature sensor (not shown). The case 400 may also include a cathode terminal 413 and an anode terminal 414.

On the front side 402 and rear side 406 of the battery case 400, there are a plurality of ridges 415 to allow space between two adjacent battery modules. The space between two adjacent battery modules enables efficient cooling of the two adjacent battery modules. The plurality of ridges 415 may further allow interlocking of two adjacent battery modules. The ridges 415 may also prevent accidentally mixing the lithium battery cells with preexisting Ni-MH battery cells in a battery pack.

In one example implementation, the battery case 400 may further include a plurality of perforations 416 on each of the top side 410 and the underside 411. The plurality of perforations 416 allow for the heat exchange of the plurality of battery cells 302 through enhanced air flow.

In yet another implementation, the battery case 400 may further include dividers (not shown) such that the lithium battery cells (e.g., battery cells 302 in FIG. 3) can be stored inside smaller compartments to prevent movement of the battery cells while the vehicles are in motion.

As depicted in FIG. 3, in some implementations of the disclosure, the battery cell structure 300 may include five lithium battery cells 302 that are electrically connected in series and are rechargeable. In the implementation illustrated in FIG. 3, two battery cells 302 may be layered in a first row and three battery cells 302 may be layered in a second row parallel to the first row. The plurality of battery cells 302 may be stored inside the case 400 or in a layered configuration in the case 400 to interlock the battery cells to an existing hardware.

The lithium battery cells (e.g., 302 in FIG. 3) may include lithium titanate Li₄Ti₅O₁₂, lithium iron phosphate LiFePO₄, lithium cobalt oxide LiCoO₂, lithium manganese oxide LiMn₂O₄, lithium nickel manganese cobalt oxide LiNiMnCoO₂ (or NMC), lithium nickel cobalt oxide LiNiCoO₂ (or NC), or lithium nickel cobalt aluminum oxide LiNiCoAlO₂.

In some implementations of the present disclosure, the battery cells may include Li₄Ti₅O₁₂ cells, and the number of battery cells within an example LiFePO₄ battery cell structure 300 may be seven. For example, three Li₄Ti₅O₁₂ battery cells may be layered in a first row, and four Li₄Ti₅O₁₂ battery cells may be layered on a second row parallel to the first row.

In some implementations of the present disclosure, the battery cells may include LiFePO₄ cells, and the number of battery cells within an example LiFePO₄ battery cell structure 300 may be five. For example, three LiFePO₄ battery cells may be layered in a first row, and two LiFePO₄ battery cells may be layered in a second row parallel to the first row.

In another implementation of the present disclosure, the battery cells may include LiCoO₂ cells, and the number of battery cells within an example LiFePO₄ battery cell structure 300 may be four. For example, two LiCoO₂ battery cells may be layered in a first row, and two LiCoO₂ battery cells may be layered in a second row parallel to the first row.

In some implementations of the present disclosure, the battery cells may include LiMn₂O₄ cells, and the number of battery cells within an example LiFePO₄ battery cell structure 300 may be four. For example, two LiMn₂O₄ battery cells may be layered in a first row, and two LiMn₂O₄ battery cells may be layered in a second row parallel to the first row.

In another implementation of the present disclosure, the battery cells may include LiNiMnCoO₂ cells, and the number of battery cells within an example LiFePO₄ battery cell structure 300 may be four. For example, two LiNiMnCoO₂ battery cells may be layered in a first row, and two LiNiMnCoO₂ battery cells may be layered in a second row parallel to the first row.

In some implementations of the present disclosure, the battery cells may include LiNiCoO₂ cells, and the number of battery cells within an example LiFePO₄ battery cell structure 300 may be four. For example, two LiNiCoO₂ battery cells may be layered in a first row, and two LiNiCoO₂ battery cells may be layered in a second row parallel to the first row.

In another implementation of the present disclosure, the battery cells may include LiNiCoAlO₂ cells, and a number of battery cells within an example LiFePO₄ battery cell structure 300 may be four. For example, two LiNiCoAlO₂ battery cells may be layered in a first row, and two LiNiCoAlO₂ battery cells may be layered in a second row parallel to the first row.

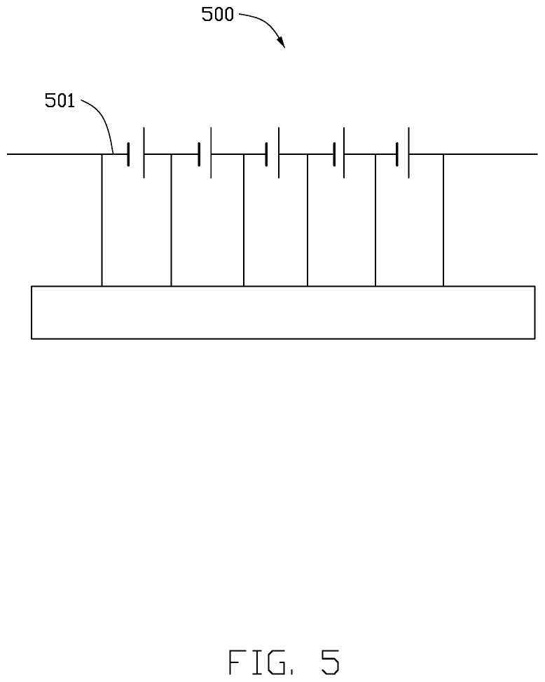

FIG. 5 is a schematic drawing illustrating an example voltage balancing module 500 in accordance with an example implementation of the present disclosure. The voltage balancing module 500 includes five balancing circuits 501. Each balancing circuit monitors and regulates a voltage of each of the plurality of rechargeable battery cells (e.g., 302 in FIG. 3). The five balancing circuits 501 are connected in series. The voltage balancing module 500 may include a balancing circuit board 600.

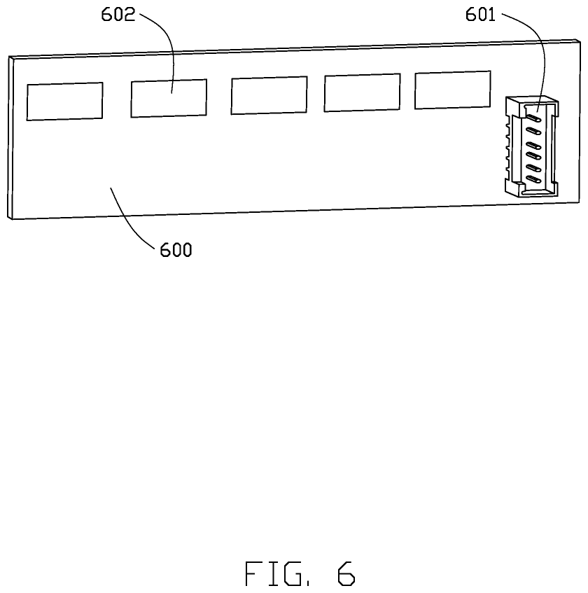

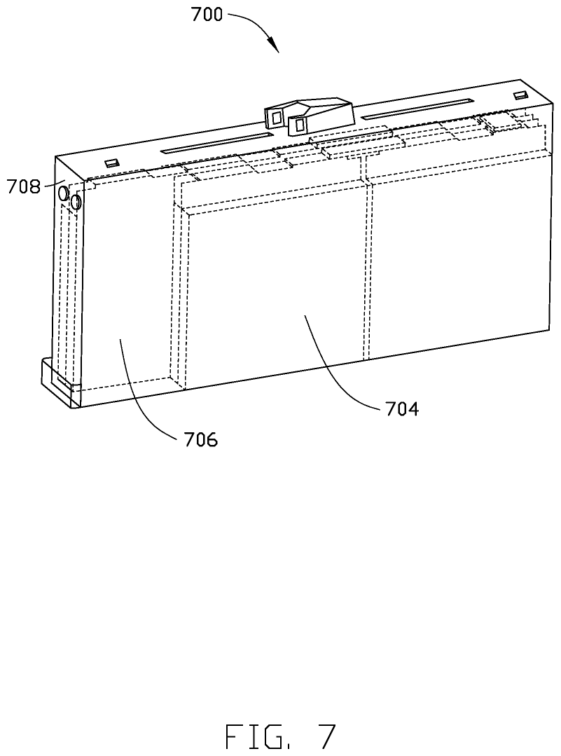

FIG. 6 is a schematic drawing illustrating the balancing circuit board 600. For example, five electric contacts 601 are provided at one corner of the balancing circuit board 600. Each electric contact 601 connects to a battery cell in the battery module (e.g., 700 in FIG. 7). The balancing circuit board 600 may also include, for example, five groups of resistors 602. In some implementations, three resistors 602 may be included in each group. The balancing circuit board 600 may further include additional circuit elements (not shown) to monitor voltage of each individual lithium battery cell within the battery module. For example, when the circuit element detects voltage of a cell that exceeds a pre-set voltage, the circuit element would connect the battery to the corresponding resistor group, and may discharge any excess voltage through the resistors 602. The voltage balancing module 500 may prevent the battery cells within the module from being overcharged at any time, especially during vehicle braking that may cause a surge in charging current.

FIG. 7 is a schematic drawing illustrating an example LiFePO₄ battery module with a balancer in accordance with an example implementation of the present disclosure.

FIG. 7 illustrates a 5-Series (5S) LiFePO₄ battery module 700. In some implementations of the present disclosure, the LiFePO₄ battery module 700 may include five battery cells 704 with two rows in a battery module casing 708, where there are three battery cell spots in each row. The voltage balancing module 510 may be arranged inside an empty compartment 706 within the battery module casing 708. The voltage balancing module 510 may be electrically connected to each of the plurality of battery cells 704.

Each of the plurality of battery cells 704 may have a nominal voltage. The plurality of battery cells 704 may have a combined nominal voltage. In some implementations, the nominal voltage for a LiFePO₄ battery cell may be 3.2V. The battery module 700 with five LiFePO₄ battery cells 704 may have a combined nominal voltage of 16 V. The nominal voltage of a battery module in the related art (e.g., Ni-MH-based battery module 200 in FIG. 2) having six Ni-MH battery cells is approximately 7.2V, and two Ni-MH-based battery modules may have a combined nominal voltage of 14.4V. That is to say, a battery module with five LiFePO₄ battery cells may replace two battery modules with six Ni-MH battery cells in each battery module. In a HEV applying the battery module in the related art, there are twenty-eight Ni-MH-based battery modules, which may equal to a total combined nominal voltage of 201.6 V. As such, fourteen example LiFePO₄ battery modules of the present disclosure, having a total combined nominal voltage of 224 V, may replace twenty-eight Ni-MH-based battery modules.

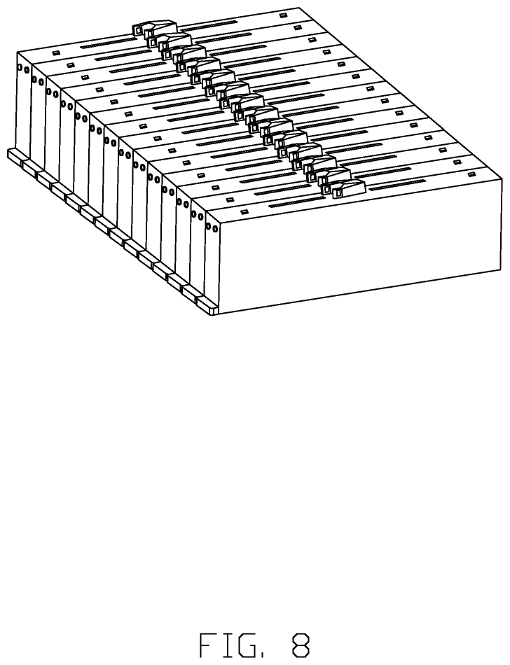

FIG. 8 illustrates fourteen example LiFePO₄ battery modules (e.g., 700 in FIG. 7) as replacement for the twenty-eight Ni-MH-based battery modules to supply power for an entire Toyota® Prius®. As illustrated in FIG. 8, the LiFePO₄ battery modules are electrically connected in series. When two Ni-MH-based battery modules in the related art (e.g., Ni-MH-based battery module 200 in FIG. 2) weigh about 2.07 kg, a LiFePO₄ battery module (e.g., 700 in FIG. 7) weighs about 1.23 kg. That is to say, replacing a stack of twenty-eight Ni-MH based battery modules with a stack of fourteen example LiFePO₄ battery modules (e.g., 700 in FIG. 7) reduces the weight from 28.98 kg to 17.22 kg.

To preserve the longevity of the lithium battery cells of the present disclosure, a voltage threshold is set by the voltage balancing module (e.g., 510) that is lower than the maximum charging voltage for each lithium battery cell. To promote energy efficiency of the lithium battery cells of the present disclosure, it is preferred that the voltage threshold set by the voltage balancing module (e.g., 510) is higher than the nominal voltage of each lithium battery cell. When the voltage balancing module detects that the voltage threshold is reached for any individual battery cell, the excessive energy of the battery cell is dissipated. The prevention of overcharging or charging to saturation of each individual battery cells may maintain an overall balanced state.

In some implementations, the nominal voltage may be set slightly higher than the designed nominal voltage such that a processor in an HEV may determine a presence of excessive battery power, which may promote electrical power usage over combustion power usage, thus contributing to an increase in fuel economy while providing faster acceleration.

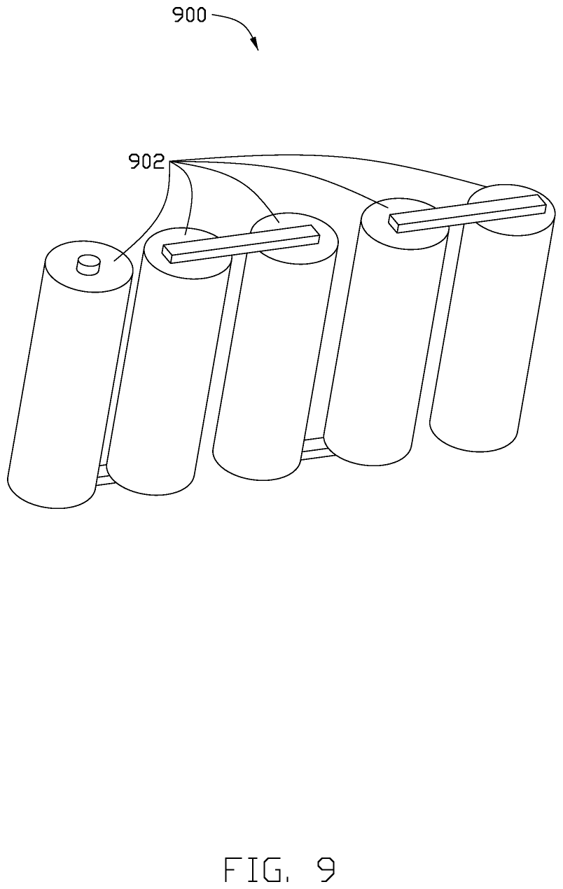

FIG. 9 is a schematic drawing illustrating an example sodium-based battery cell structure, in accordance with an example implementation of the present disclosure.

FIG. 9 illustrates an example Na-based or an Na-ion battery cell structure 900 having a 5-series (5S) configuration. In some implementations of the present disclosure, the Na-ion battery cell structure 900 may include five Na-ion battery cells 902 that are electrically connected in series. In some implementations, the five Na-ion battery cells 902 may be arranged in a row, as shown in FIG. 9. In some implementations, each of the five Na-ion battery cells 902 may have a cylindrical housing. In other implementations, each of the five Na-ion battery cells 902 may have a pouch-shaped housing similar to the shape of the cells 302 in FIG. 3. In yet some other implementations, the Na-ion battery cells 902 may have other shapes.

Although the Na-ion battery cell structure 900 shown in FIG. 9 has a 5-series configuration, in some other implementations, the Na-ion battery cell structure 900 may have a 2-series configuration, a 15-series configuration, etc., to have different capacities and/or C-rate, according to the needs of different HEVs.

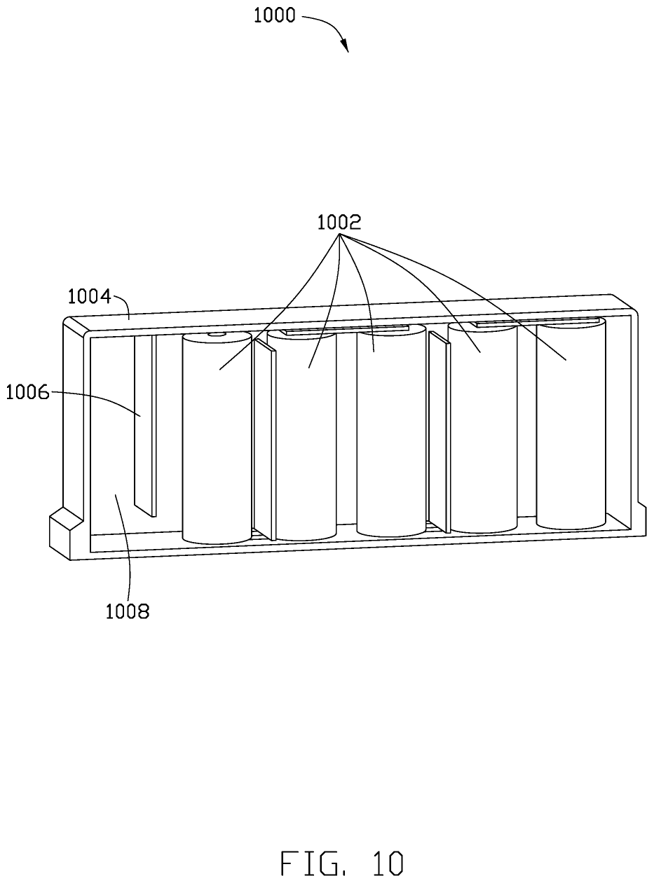

In some implementations of the present disclosure, the Na-ion battery cells (e.g., battery cells 902) may be protected by a battery module casing (e.g., casing 1004, as shown in FIG. 10), which may include multiple perforations (not shown in the figure, but similar to, for example, perforation 416 shown in FIG. 4). Such perforations, or similar structures, may allow for the heat exchange of the five Na-ion battery cells (e.g., through enhanced air flow and dividers), such that the Na-ion battery cells may be steadily stored inside smaller compartments (e.g., of the battery module casing) to prevent movement of the Na-ion battery cells while the vehicle is in motion.

FIG. 10 is a schematic drawing illustrating an example sodium-based battery module with a balancer, in accordance with an example implementation of the present disclosure.

FIG. 10 illustrates an Na-based battery module or an Na-ion battery module 1000 having a 5S configuration. In some implementations of the present disclosure, the Na-ion battery module 1000 may include five Na-ion battery cells 1002 (similar to battery cells 902 shown in FIG. 9) that are electrically connected in series and may be arranged in a row within a battery module casing 1004. The Na-ion battery module 1000 may also include a voltage balancing module 1006 (e.g. similar to the voltage balancing module 500 shown in FIG. 5) having circuitry (e.g., similar to the circuitry 501) on a circuit board (e.g., similar to the circuit board 600 shown in FIG. 6). The voltage balancing module 1006 may be arranged inside a (e.g., hollow) compartment 1008 within the battery module casing 1004.

The voltage balancing module 1006 may be electrically connected to each of the plurality of Na-ion battery cells 1002 for monitoring and regulating the voltage of each Na-ion battery cell 1002. For example, when the voltage balancing module 1006 detects that the voltage of an Na-ion battery cell 1002 exceeds a pre-set voltage, the voltage balancing module 1006 may connect the Na-ion battery cell 1002 to a corresponding resistor group (not shown in the figure), and may discharge the excess voltage through the resistor group. The voltage balancing module 1006 may prevent the Na-ion battery cells 1002 within an Na-ion battery module 1000 from being overcharged at all times, especially during vehicle braking, which may cause a surge in charging current.

In some implementations, each of the battery cells 1002 may have a nominal voltage. The Na-ion battery cells 1002 may have a combined nominal voltage. In some implementations, the nominal voltage for an Na-ion battery cell (e.g., a single cylindrical cell 1002) may be 3.1V. The Na-ion battery module 1000 having five Na-ion battery cells 1002 may have a combined nominal voltage of 15.5 V in some implementations. The nominal voltage of a single battery module in the related art (e.g., Ni-MH-based battery module 200 in FIG. 2) having six Ni-MH battery cells is approximately 7.2V, and two Ni-MH-based battery modules (or 12 Ni-MH battery cells) may have a combined nominal voltage of 14.4V. As such, a single battery module of some implementation with five Na-ion battery cells 1004 may easily replace two battery modules with six Ni-MH battery cells in each battery module, thus rendering the Na-ion battery cells substantially more efficient.

As an example, in an HEV that applies the Ni-MH-based battery modules, twenty-eight Ni-MH-based battery modules may provide a total combined nominal voltage of 201.6 V. In contrast, for an HEV that applies the example Na-ion battery modules of the present disclosure, only fourteen Na-ion battery modules may replace the twenty-eight Ni-MH-based battery modules and yet produce a total combined nominal voltage of 217 V. Thus, the Na-ion battery module of the present disclosure may also provide a lower weight and a smaller footprint than the Ni-MH-based battery module. In other words, the Na-ion battery module may provide a higher power-to-weight ratio than the Ni-MH-based battery module.

In some implementations, to preserve the longevity of the Na-based battery cells and provide a safeguard, a voltage threshold may be set by the voltage balancing module (e.g., module 1006) that is lower than the maximum charging voltage for each N-based battery cell. To promote energy efficiency of the N-based battery cells of the present disclosure, it may be preferred that the voltage threshold set by the voltage balancing module (e.g., module 1006) be higher than the nominal voltage of each N-based battery cell. When the voltage balancing module detects that any individual battery cell has reached the voltage threshold, the excessive energy of the battery cell may be dissipated. The prevention of overcharging, or charging, to saturation of each individual battery cell may maintain an overall balanced state for the battery module.

In some implementations, the nominal voltage may be set slightly higher than the designed nominal voltage, such that a processor in an HEV may determine a presence of excessive battery power, which may promote electrical power usage over combustion power usage, thus contributing to an increase in the overall fuel economy of the HEV, while providing faster acceleration.

In some implementations, a sodium-based or Na-based battery cell may be more desirable than a lithium battery cell due to its affordability, its wider operating temperature range (e.g., −40 degrees ° ° C. to 60 degrees)° ° C., and wider operating voltage range when compared to both the lithium battery cell and nickel battery cells. Moreover, an Na-based battery cell may have a higher power density, a higher power output, a higher capacity, less modules/materials/manufacturing costs, and a better charging efficiency than a nickel battery cell, which makes the Na-based battery cell ideal to replace the nickel battery cell. As discussed above, an Na-based battery cell may also store the same amount of charge in a smaller footprint than the nickel battery cell, which may also make the use of Na-based battery cells in the HEVs more desirable than the nickel battery cell in many different aspects.

The example implementations of the Na-ion rechargeable batteries provided in the present disclosure may be used as rechargeable batteries to replace lithium batteries and/or nickel batteries in HEVs. In the present disclosure, the example battery case, circuitry, and other physical components of the Na-ion rechargeable batteries may be similar to those described in the example lithium/nickel batteries, but are not limited to examples provided herein, as the Na-ion rechargeable batteries may include hardware and software designs that are also compatible with the HEVs previously installed lithium and/or nickel batteries, such that the Na-ion rechargeable batteries may be smoothly secured with the existing hardware (e.g., sufficient mounting points for existing sensors/harnesses may be provided, sufficient gaps between battery modules for appropriate air circulation, etc.) or smoothly interact with the existing software of the HEV, and such that the users may be prevented from installing the battery module/case in an incorrect orientation and/or confusing the Na-ion rechargeable batteries with the lithium and/or nickel rechargeable batteries.

Even though numerous characteristics and advantages of the present technology have been set forth in the foregoing description, together with details of the structure and function of the present disclosure, the disclosure is illustrative only, and changes may be made in the detail, especially in matters of shape, size, and arrangement of the parts within the principles of the present disclosure, up to and including the full extent established by the broad general meaning of the terms used in the claims. It will therefore be appreciated that the implementations described above may be modified within the scope of the claims.

What is claimed is:

1. A battery module for a vehicle, the battery module comprising:
a case;
a plurality of sodium-ion rechargeable battery cells stored inside the case and connected in series, wherein each of the plurality of sodium-ion rechargeable battery cells has a nominal voltage and a maximum voltage; and
an overcharge protection circuit having a voltage threshold for preventing an overcharging of each of the plurality of sodium-ion rechargeable battery cells, wherein the voltage threshold is larger than the nominal voltage and smaller than the maximum voltage.

2. The battery module of claim 1, wherein the nominal voltage of each of the plurality of sodium-ion rechargeable battery cells is the same.

3. The battery module of claim 1, wherein the plurality of sodium-ion rechargeable battery cells comprises five cells.

4. The battery module of claim 3, wherein the five cells provide a combined nominal voltage of 15.5V.

5. The battery module of claim 1, wherein each of the plurality of sodium-ion rechargeable battery cells has a cylindrical-shaped housing.

6. The battery module of claim 1, further comprising an operating temperature from −40 degrees ° C. to 60 degrees ° C.

7. The battery module of claim 1, wherein the overcharge protection circuit prevents the overcharging of each of the plurality of sodium-ion rechargeable battery cells through dissipation via resistors.

8. The battery module of claim 1, further comprising:
a battery-free cell space for storing the overcharge protection circuit.

9. A battery module for a vehicle, the battery module comprising:
a case;
a plurality of sodium-ion rechargeable battery cells stored inside the case and connected in series, wherein the plurality of sodium-ion rechargeable battery cells is stored in a parallel configuration inside the case, and each of the plurality of sodium-ion rechargeable battery cells has a nominal voltage and a maximum voltage; and
an overcharge protection circuit having a voltage threshold for preventing an overcharging of each of the plurality of sodium-ion rechargeable battery cells, wherein the voltage threshold is larger than the nominal voltage and smaller than the maximum voltage.

10. The battery module of claim 9, wherein the nominal voltage of each of the plurality of sodium-ion rechargeable battery cells is the same.

11. The battery module of claim 9, wherein the plurality of sodium-ion rechargeable battery cells comprises five cells.

12. The battery module of claim 11, wherein the five cells provide a combined nominal voltage of 15.5V.

13. The battery module of claim 9, wherein each of the plurality of sodium-ion rechargeable battery cells has a pouch-shaped housing.

14. The battery module of claim 9, further comprising an operating temperature from −40 degrees ° C. to 60 degrees ° C.

15. The battery module of claim 9, wherein the overcharge protection circuit prevents overcharging of each of the plurality of sodium-ion rechargeable battery cells through dissipation via resistors.

16. The battery module of claim 9, further comprising:
a battery-free cell space for storing the overcharge protection circuit.
